(19) United States
(12) Patent Application Publication
(10) Pub. No.: US 2006/0034167 A1
(43) Pub. Date: Feb. 16, 2006

(54) Communication resource reservation system for improved messaging performance

(75) Inventors: Donald G. Grice, Gardiner, NY (US); Dominique A. Heger, Dripping Springs, TX (US); Steven J. Martin, Poughkeepsie, NY (US); Johannes M. Sayre, Kingston, NY (US); Amor S. Scheftel, Millwood, NY (US); Appoloniel N. Tankeh, Fishkill, NY (US)

Correspondence Address: INTERNATIONAL BUSINESS MACHINES CORPORATION, IPLAW DEPARTMENT, 2455 SOUTH ROAD - MS P386, POUGHKEEPSIE, NY, 12601, US

(73) Assignee: INTERNATIONAL BUSINESS MACHINES CORPORATION, ARMONK, NY (US)

(21) Appl. No.: 10/903,322

(22) Filed: Jul. 30, 2004

(51) Int. Cl. H04L 12/26

(52) U.S. Cl. 370/229

(57) ABSTRACT

A system and method are provided for facilitating zero-copy communications between computing systems of a group of computing systems. The method includes allocating, in a first computing system of the group of computing systems, a pool of privileged communication resources from a privileged resource controller to a communications controller. The communications controller designates the privileged communication resources from the pool for use in handling individual ones of the zero-copy communications, thereby avoiding a requirement to obtain individual ones of the privileged resources from the owner of the privileged resources at setup time for each zero-copy communication.

### BACKGROUND OF THE INVENTION

The present invention relates to communications by a processor within a system of multiple processors or over a network.

One of the performance bottlenecks of computing systems which include multiple processors, is the speed at which data are transferred in messages between processors. Communication bandwidth, defined as the amount of data transferred per unit of time, depends on a number of factors which include not only the transfer rate between processors of a multiple processor system, but many others. Factors which determine communication bandwidth typically include both fixed cost factors which apply to all messages regardless of their length, and variable cost factors which vary in relation to the length of the message.

In order to best describe the factors affecting communication bandwidth, it is helpful to illustrate a computing system and various methods used to transfer messages between processors of such system. FIG. 1 is a block diagram showing an exemplary multiple processor system 100 according to the prior art. As shown in FIG. 1, system 100 includes a plurality of processors 110 at each of a plurality of respective nodes 120. Each processor 110 can be referred to as a “host system”. Each processor is implemented as a single processor having a single CPU or as a multiple processor system having a plurality of CPUs which cooperate together on processing tasks. An example of a processor 110 is a server such as a “Symmetric Multiprocessor” (SMP) system sold by the assignee of this application. Illustratively, a server such as an SMP may have from a few CPUs to 32 or more CPUs. Each processor, e.g., each server, includes a local memory 115. Each processor 110 operates semi-autonomously, performing work on tasks as required by user applications and one or more operating systems that run on each processor, as will be described further with respect to FIG. 4. Each processor is further connected via a bus 112 to a communications adapter 125 (hereinafter, “adapter”) at each node 120. The adapter, in turn, communicates with other processors over a network, the network shown here as including a switch 130, although the network could have a different topology such as bus, ring, tree, etc. Depending on the number of CPUs included in the processor 110, e.g., whether the processor is a single CPU system, has a few CPUs or is an SMP having many CPUs, the adapter can either be a stand-alone adapter or be implemented as a group of adapter units. For example, when the processor 110 is an SMP having 32 CPUs, eight adapter units, collectively represented as “adapter” 125, service the 32 CPUs and are connected to the 32 CPUS via eight input output (I/O) buses, which are collectively represented as “bus” 112. Each processor is connected to other processors within system 100 over the switch 130, and to storage devices 140. Processors 110 are also connected by switch 130 to an external network 150, which in turn, is connected to one or more external processors (not shown).

Storage devices 140 are used for paging in and out memory as needed to support programs executed at each processor 110, especially application programs (hereinafter “applications”) at each processor 110. By contrast, local memory 115 is available to hold data which applications are actively using at each processor 110. When such data is no longer needed, it is typically paged out to the storage devices 140 under control of an operating system function such as “virtual memory manager” (VMM). When an application needs the data again, it is paged in from the storage devices 140.

Communications between processors 110 of the system can be handled in one of two basic ways. A first way, which is referred to as a “copy mode” transport mechanism, is illustrated with respect to FIG. 2. As shown therein, a message is to be sent from one user buffer 200 of one processor (not shown) to another user buffer 202 of another processor (not shown). Each user buffer is an area of memory, especially the local memory 115 (FIG. 1) which stores data being used by an application or task running on the respective processor. To send a message by this transport mechanism, an application calls a message handling facility such as Message Passing Interface (MPI), for example. MPI calls the appropriate lower layer communication protocol, such as LAPI (Lower Layer Application Programming Interface), which calls HAL (Hardware Abstraction Layer) in turn. MPI, LAPI and HAL, together with the adapter 125a, perform the necessary operations to transfer the payload data of the message, as will be described further below with respect to FIG. 4. As part of the transfer process, the payload data is copied from the user buffer 200 to a send buffer 210, which is, for example, a HAL send FIFO (first-in-first-out) buffer. From the send buffer 210, the adapter 125a then copies the payload data to a memory 135 reserved for its own use, from which the adapter then sends the data through the switch 130 to the adapter 125b at the receiving end. During the data transfer operation, the adapter 125a need not wait for all of the data to be copied into the send buffer 210 to copy data into its own memory 135. Instead, such copying begins as soon as data is available in the send buffer 210 and the adapter 125a has performed appropriate handshaking. The adapter 125a begins sending the data over switch 130 as soon as sufficient data is available in its memory 135 to send. At the receiving end, in turn, the receiving adapter 125b copies data as it is received into a receive buffer 220 (illustratively, a HAL receive FIFO). From the receive buffer 220, the data is copied to the user buffer 202 as soon as some of the data is ready to be copied from the receive buffer 220.

Similarly, when an application in user buffer 202 sends a message, the data is copied from the user buffer 202 into the send buffer 210b, from which it is copied into adapter memory 135b. From there sent over switch 130 to memory 135a of adapter 125a. The data is copied from adapter memory 135a into receive buffer 220a, and from there it is copied into user buffer 200.

The copy mode transport mechanism provides an efficient way of sending and receiving messages having relatively small amounts of data between processors, because this mechanism traditionally requires little time to set up the data transfer operation. However, for larger amounts of data, the copying time becomes excessive for the intermediate steps of copying the data from the user buffer 200 to the send buffer 210 on the send side, and from the receive buffer 220 to the user buffer 202 on the receive side. For this reason, various methods have been proposed for transferring data between processors which omit these intermediate steps of copying the data. Such methods are known generally as “zero copy” transport mechanisms. An example of such zero copy transport mechanism is shown in FIG. 3. As shown therein, data is copied directly from the user buffer 200 to the adapter memory 135, and the adapter 125a sends the data over the switch 130 to the receiving adapter 125b. From the memory 135b of the receiving adapter 125b the data is copied directly into the user buffer 202. Similarly, when an application in user buffer 202 sends a message, the data is copied from the user buffer 202 to the adapter memory 135b, and from there sent over switch 130 to memory 135a of adapter 125a, and from there it is copied into user buffer 200.

FIG. 4 illustrates an exemplary communication protocol stack operating on a processor 110 of a system 100 such as that shown in FIG. 1. As shown in FIG. 4, the resources of the processor, including its memory, CPU instruction executing resources, and other resources, are divided into logical partitions LPAR1, LPAR2, LPAR3, LPAR4, LPAR5, . . . , LPAR N. In each logical partition, a different operating system (OS-DD 402) may be used, such that to the user of the logical partition it may appear that the user has actual control over the processor. In each logical partition, the operating system, e.g., 402a, 402b, etc., controls access to privileged resources. Such resources include translation tables that include translation information for converting addresses such as virtual addresses, used by a user space application running on top of the operating system, into physical addresses for use in accessing the data.

However, there are certain resources that even the operating system is not given control over. These resources are considered “super-privileged”, and are managed by a Hypervisor layer 450 which operates below each of the operating systems. The Hypervisor 450 controls the particular resources of the hardware 460 allocated to each logical partition according to control algorithms, such resources including particular tables and areas of memory that the Hypervisor 450 grants access to use by the operating system for the particular logical partition. The computing system hardware 460 includes the CPU, its memory (not shown) and the adapter 125. The hardware typically reserves some of its resources for its own purposes and allows the Hypervisor to use or allocate the rest of its resources, as for example, to each logical partition.

Within each logical partition, the user is free to select the user space applications and protocols that are compatible with the particular operating system in that logical partition. Typically, end user applications operate above other user space applications used for communication and handling of data. For example, in LPAR2, the operating system 402b is AlX, and the communication protocol layers HAL 404, LAPI 406 and MPI 408 operate thereon in the user space of the logical partition. One or more end user applications operate above the MPI layer 408. On the other hand, in LPAR 4, the operating system 402c is LINUX, and the communication protocol layers KHAL 410 (kernel version hardware abstraction layer), KLAPI 412 (kernel version LAPI) and GPFS 414 (“General Parallel File System”) operated thereon on the user space of the logical partition. Other logical partitions may use other operating systems and/or other communication protocol stacks such as Transport Control Protocol (TCP) 420 and Internet Protocol (IP) 422 in LPAR 3 and Asynchronous Transfer Mode (ATM) 430 over an upper layer protocol (ULP) 432 in LPAR 5. Still another combination may run in an LPAR N, such as Internet Small Computer System Interface (iSCSI) 440, operating over an upper layer protocol (ULP) 442 and HAL 444.

One difficulty of conventional zero copy transport mechanisms is the setup time required to prepare a message to be sent. This will be described with respect to FIG. 5. As shown therein, in a conventional method of sending a message by a zero copy transport mechanism, several setup steps are required. The method begins with a request 500 from a protocol layer such as MPI based on a need of an end user application, for example. The length of the message (MSGLENGTH) and the virtual address (VADDR) are provided with the request. While virtual address is used by the end user application, a physical address is needed in order for the adapter to copy the data to its memory to be sent by the zero copy transport mechanism. MPI passes the request to a lower protocol such as LAPI, which in turn, passes the request to HAL. HAL recognizes that resources are needed to send the message, including a channel (division of adapter transport resource) on which to send the message, and an area of reserved system memory for use in storing a table including address translation information for the data to be sent. One or more other tables, and other resources may also be needed. As indicated at 510, since these resources are privileged or super-privileged, HAL forwards a request for resource allocation to the operating system, which then allocates the privileged resource under its control. However, the operating system must call the Hypervisor to obtain any super-privileged resources.

Thereafter, after the necessary resources are allocated, as shown at 520, address translation for converting from virtual addresses to physical addresses must be done to prepare the message to be sent. This step is carried out in units of “pages”, a page being a common unit of data to be accessed typically by one transfer instruction. Conventionally, a page contains 4K bytes of data. The pages to be translated are identified from the virtual (starting) address and the message length provided by the initial message request.

Here, two operations are actually required. The first required operation is to “pin” each page of the data to be transferred by the message. To “pin” a page means to lock its location, i.e., to fix the relationship between the virtual address and the physical address so that no other application such as a virtual memory manager (VMM) can transfer the page to a different physical address, e.g., by “paging out” that page from the local memory 115 of a processor 110 to a storage device 140 (FIG. 1). Only pinned pages can be transferred by the zero copy transport mechanism. Thereafter, translation information is obtained for each page to be transferred. These operations are best described with reference to FIGS. 7A and 7B. FIG. 7A illustrates the pinning operation as a two-step process of traversing a PTE table, which is a chain of at least two tables. As shown therein, an address such as a virtual address of data to be transferred, with an offset representing a particular page thereof, is presented to the first table 700 in the chain of tables of a PTE table maintained by an operating system. The first table 700 associates particular ranges of virtual addresses ADDR RANGE 1, ADDR RANGE 2, etc., to particular tables, i.e., to tables TBL 1, TBL 2, etc., respectively. By traversing the first table 700, a table, e.g., TBL 2 (“Table 2”) is identified in kernel memory which relates virtual page addresses to physical addresses through an entry called a “page table entry” (PTE). By traversing the second table 710 (“Table 2”), the page entry is located and pinned. This operation is then repeated for the next succeeding page of the memory to be sent, the one thereafter, and so on, until the entire length of the message data to be sent has been pinned. Thus, the first table 700 and Table 2 (710) must be traversed once for each page address to be pinned. FIG. 7A shows an example in which three pages PAGE ADDR 1, PAGE ADDR 2, and PAGE ADDR 3 are to be sent, and are therefore pinned. Thereafter, with reference to FIG. 7B, translation information, i.e., a PTE, is fetched for each page of the message data to be sent. Here again, the first table 700 is consulted to identify the table (Table 2) on which the page translation information is located. Table 2 (710) is then consulted to obtain the PTE for each page to be sent. Again, the first table 700 and Table 2 (710) must be traversed once for each page address to be translated.

These are time intensive operations, as will be apparent from the following. Regardless of the size of the message to be sent, addresses need to be pinned on basis of pages, and pages are 4K bytes in size. As used herein, “byte” means eight bits and is denoted as “B”, “K” means the number 1024 and “M” means the number K², i.e., 1024×1024, which, to multiply it out, is 1,048,576. Similarly, “G” means the number K×M, i.e., 1024M, which can be expressed as 1024×1024×1024=1,073,741,824. These numbers “K” and “M” are conveniently used to refer to the amounts of bytes of data and other units of information handled by computers.

When the amount of data to be transferred by a message is 16M, which is 4096 pages, i.e. 4K pages of 4K size each, then these pinning and address translation operations require that the chain of PTE tables be traversed a great number of times. Since each of the 4K (i.e., 4096) addresses must be looked up by way of the first table 700 and then by Table 2 (710) in the pinning operation, a total of 8K lookups are performed to pin the addresses. Then, in the translating operation, the PTE must be fetched for each of the 4K addresses by way of the first table 700 and then by Table 2 (710). Here, the two tables are traversed a total of 8K times to fetch the PTEs. All total, 16K table traversals are performed to pin and translate addresses for the 16M message.

FIG. 6 illustrates another problem of the prior art in the manner that resources are allocated for use in transmitting messages by way of zero copy transport mechanisms. As shown therein, channels, translation tables (TTBL 1, TTBL 2, etc.) and miscellaneous tables and resources, shown collectively, as MISC TBL1, MISC TBL 2, etc., are allocated statically, with each channel resource being allocated together with a designated translation table. Thus, for instance, a particular channel CHAN 1 can only be allocated together with a particular translation table TTBL 1 and particular miscellaneous tables (MISC TBL 1). On the other hand, a particular channel CHAN 2 can only be allocated together with a particular translation table TTBL 2 and particular miscellaneous tables (MISC TBL 2). When a message, e.g., MSG 1 has finished using a particular combination of channel and table resources, that combination can be reallocated for another message, e.g., MSG 4, as shown, but only as the same combination of resources. Such static allocation can be problematic, because the needs for a particular message might not correspond well with the combinations of the channel resources and the translation table resources that are available. The translation table may be longer than necessary or shorter than required, or the particular channel may not have the desired transfer rate. However, while the available resources, considered individually, would meet the need, they do not in the combinations that are available to be allocated. Thus, static allocation results in some resources being unused because they can only be allocated in combination.

Therefore, from the foregoing, it is apparent that inefficiencies exist in prior art methods of transmitting messages which need to be addressed.

### SUMMARY OF THE INVENTION

According to an aspect of the invention, a method is provided for facilitating zero-copy communications between computing systems of a group of computing systems. The method includes allocating, in a first computing system of the group of computing systems, a pool of privileged communication resources from a privileged resource controller to a communications controller. The communications controller designates the privileged communication resources from the pool for use in handling individual ones of the zero-copy communications, thereby avoiding a requirement to obtain individual ones of the privileged resources from the owner of the privileged resources at setup time for each zero-copy communication.

According to another aspect of the invention, a machine-readable recording medium having instructions thereon for performing a method of facilitating zero-copy communications between computing systems of a group of computing systems, in which the method includes allocating, in a first computing system of the group of computing systems, a pool of privileged communication resources from a privileged resource controller to a communications controller. The communications controller designates the privileged communication resources from the pool for use in handling individual ones of the zero-copy communications, thereby avoiding a requirement to obtain individual ones of the privileged resources from the owner of the privileged resources at setup time for each zero-copy communication.

According to yet another aspect of the invention, a communications resource controller is provided which is operable to facilitate zero-copy communications between computing systems of a group of computing systems. The communications resource controller includes means for allocating, in a first computing system of the group of computing systems, a pool of privileged communication resources from a privileged resource controller, and means for designating ones of the privileged communication resources from the pool for use in servicing the zero-copy communications, so as to avoid a requirement to obtain individual ones of the privileged resources from the privileged resource controller at setup time for each respective zero-copy communication.

The recitation herein of a list of desirable objects which are met by various embodiments of the present invention is not meant to imply or suggest that any or all of these objects are present as essential features, either individually or collectively, in the most general embodiment of the present invention or in any of its more specific embodiments.

### DESCRIPTION OF THE DRAWINGS

The subject matter which is regarded as the invention is particularly pointed out and distinctly claimed in the concluding portion of the specification. The invention, however, both as to organization and method of practice, together with further objects and advantages thereof, may best be understood by reference to the following description taken in connection with the accompanying drawings in which:

FIG. 1 illustrates the organization of a computing system according to the prior art;

FIG. 2 illustrates a method of transmitting and receiving a message by a copy mode transport mechanism according to the prior art;

FIG. 3 illustrates a method of transmitting and receiving a message by a zero copy transport mechanism according to the prior art;

FIG. 4 illustrates an exemplary communication protocol stack operating on a processor of a system such as in the system shown in FIG. 1;

FIG. 5 illustrates a method of transmitting a message by a zero copy transport mechanism according to the prior art;

FIG. 6 illustrates an allocation of communication resources for use in transmitting messages via a zero copy transport mechanism according to the prior art;

FIG. 7A illustrates a method of pinning addresses by traversing a PTE page table according to the prior art;

FIG. 7B illustrates a method of translated pinned addresses by traversing a PTE page table according to the prior art;

FIG. 8 illustrates a method of allocating resources for use in satisfying zero copy mode message requests according to an embodiment of the invention;

FIG. 9 illustrates an allocation of communication resources for use in transmitting messages via a zero copy transport mechanism according to the invention;

FIG. 10 illustrates a method of transmitting a message via a zero copy transport mechanism according to an embodiment of the invention;

FIG. 11 illustrates a method of handling a message request according to an embodiment of the invention; and

FIG. 12 illustrates a method of handling a message request according to another embodiment of the invention.

### DETAILED DESCRIPTION OF THE INVENTION

Accordingly, in the embodiments of the invention described herein, the prior art inefficiencies of transmitting messages between processors of a system or over a network are addressed. Inefficiencies are addressed as follows. A local “master controller” is established for each logical partition of a processor, having the function of assigning privileged communication resources to user applications for their use in transmitting messages via a zero copy mechanism. By the master controller assigning the communication resources, time-consuming resource allocation requests to the operating system, the Hypervisor and to the adapter can be avoided.

The master controller is implemented partly in a lower layer application programming interface and in a device driver (DD) of the operating system. Pools of privileged and super-privileged communication resources are allocated to the master controller from resources owned by the Hypervisor, the operating system and the adapter at time of initialization, e.g., at time of initial program load (IPL). The pools of resources include particular regions of memory, channels, translation tables, miscellaneous tables, and data structures of the operating system kernel. The master controller monitors the available resources in the pools and dynamically maintains the number of resources available according to targets.

Static assignments of particular combinations of communication resources are avoided. In an embodiment of the invention, memory is allocated to user applications for zero copy messaging through a mechanism such as “malloc”. “Malloc” operations are handled by the master controller rather than the operating system. In malloc operation, the master controller allocates a particular data buffer to a user application. Such data buffer can then be referenced in a subsequent message request by the user application to perform a zero copy communication. In response to the message request, the master controller then assigns a channel from the pool of the channels that it maintains, assigns a translation table from the pool of translation tables it maintains, assigns miscellaneous tables, and assigns a data structure from the respective pools that it maintains. In an embodiment, the master controller assigns the resources independently from its assignment of any other resource, except that the resources must correspond to each other in size. Resource contention is reduced in this way by not requiring fixed combinations of resources and allowing any resources which have the requisite size to be assigned for use in satisfying a particular message request.

Address translation is avoided, when possible, by the user application referencing the same previously allocated data buffer as the source data for successive message requests. In such case, the master controller is able to simply reference a data structure containing translation information for one or more previously sent messages, and thereby avoid performing address translation. Thus, the data structure then represents a “cache” containing translation information for a data buffer which has been previously referenced in a message request. An example of such translation information is a pointer to a PTE entry in the PTE table. In one embodiment, the master controller also examines use data for each data structure, continues to retain the data structures which correspond to more recently referenced data buffers and discards the data structure when the data buffer has not been recently referenced.

If translation information for the data buffer referenced by the requested message is not available from previously performed address translation, then low-cost techniques are employed for performing translations as necessary and for passing the translation information to the adapter.

Thus, FIG. 8 illustrates a method of allocating resources for use in facilitating more efficient messaging via zero copy transport mechanisms, such as any of the zero copy mechanisms that are called by the various upper layer protocols, e.g. MPI, GPFS, ATM, etc., that operate in the various logical partitions on a particular processor. As an initial step of such method, pools of communication resources are allocated to the master controller which operates in the particular logical partition. Each logical partition preferably has a master controller, and that master controller is different from any other master controller operating in any other logical partition on the processor. Thus, the master controller is dedicated to serving the needs of applications operating in the particular logical partition to which it is assigned. The master controller is implemented partly in a lower layer application programming interface (LAPI) or other equivalent lower layer communication protocol, and partly in a device driver of an operating system. Referring to FIG. 4 again, the master controller (not shown) is implemented in the logical partition LPAR 2 partly in the LAPI 406 and partly in the OS-DD 402b.

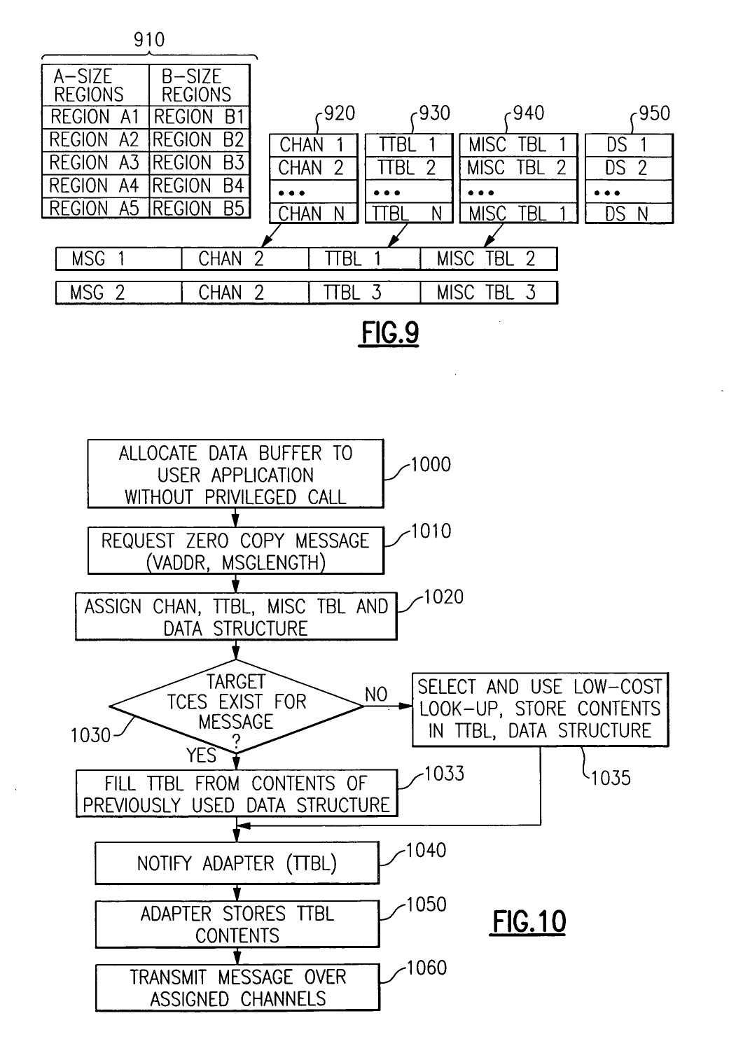

With combined reference to FIG. 8 and FIG. 4, block 800 of FIG. 8 shows that at initialization time of the operating system (e.g., 402b) of logical partition (e.g., LPAR 2), pools of privileged and super-privileged communication resources are allocated to the master controller by those elements of the processor which control them, e.g., the adapter, the operating system and the Hypervisor. The resources that are allocated include the following, as shown in FIG. 9: memory regions 910 of varying sizes, e.g., regions A1 through A5 each having a size “A” and regions B1 through B5 each having a size “B”. Pools of memory regions having great variation in sizes are most preferably allocated, in order to meet the varying needs for transferring data to and from each logical partition. For example, pools of memory regions of sizes from a few megabytes, viz. 8M, 16M, etc. up to multiple GB are allocated in this step. Thereafter, as shown at step 802, the master controller assigns a data buffer from a memory region to a particular user application in a “malloc” operation. In one embodiment, each data buffer is a desirably small portion of memory, ranging in size from a smallest number of bytes that can be transmitted efficiently via a zero copy transport mechanism, up to a large size that the user application may reference for sending a message. Thus, in one embodiment data buffers range in size from about 256K bytes up to about 256M bytes, and include every 2ⁿ size in between, n≧1.

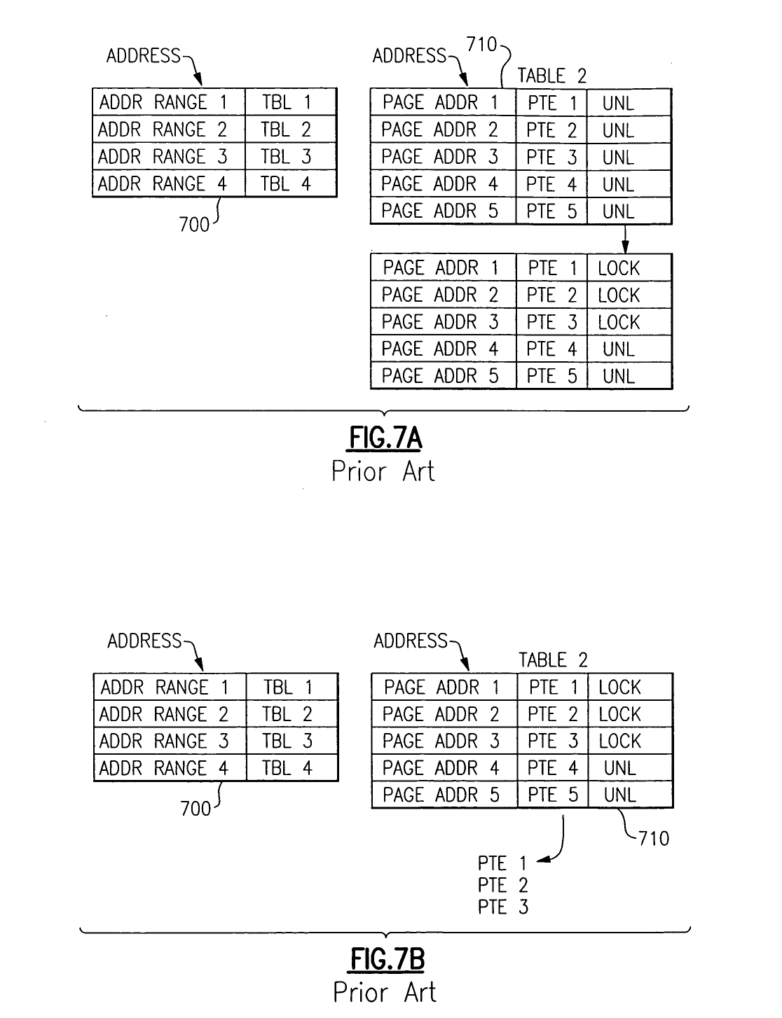

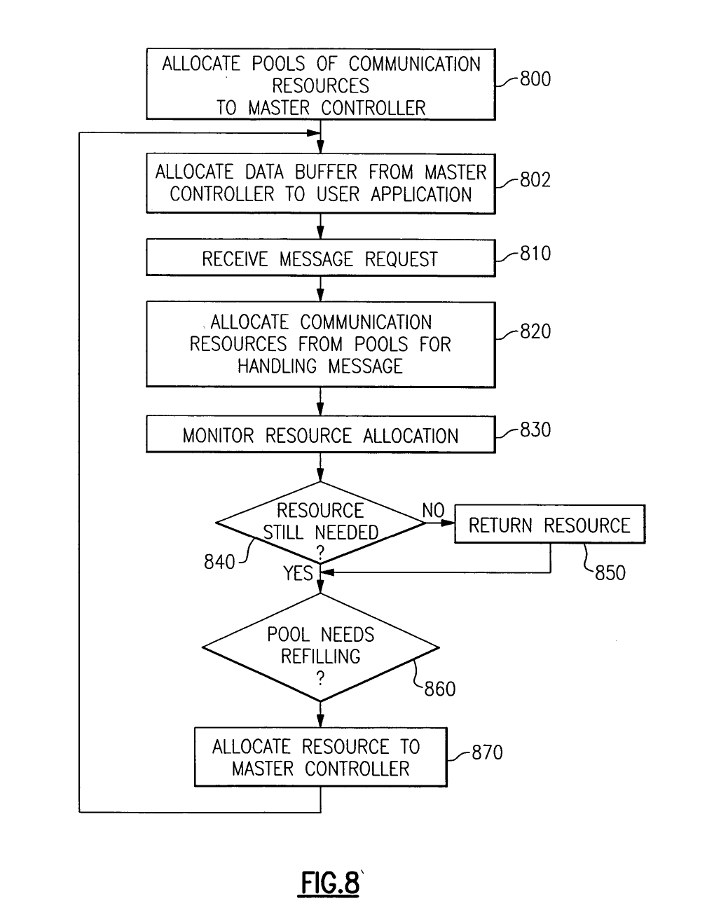

At this time, a description of the differences between different sizes of data buffers would be helpful. For smaller size data buffers, e.g., data buffers up to 16M in size, each data buffer is mapped according to a conventional page size of 4K bytes per page. However, for the larger size data buffers, e.g., such as those of 32M and larger, the data buffers can be mapped to large size pages, e.g., in which each page is 16M in size. Page translation of large data buffers according to such “large pages” is more efficient because of much reduced time in performing address translation. As an example, for a 32M data buffer in a particular memory region, when the page size is 4K, it is apparent that at least 16K traversals of the PTE table are required to perform address translation. This is because, as discussed above relative to FIGS. 7A, 7B, one traversal of the PTE table is required per each page address to pin that page address of the data buffer, and another traversal of the PTE table is required per page address to translate each page address. In addition, as noted above, an even greater number of table traversals are performed because the PTE table maintained by the Hypervisor is actually a chain of at least two tables (and sometimes a chain of three or more tables) that must be sequentially traversed. Thus, the 8K number of page entries (8K times the 4K page size=32M) of the PTE table to be traversed in each table in the chain is multiplied by the number of tables in the chain (two) to result in 16K table traversals to pin addresses and 16K table traversals to translate addresses.

However, when the page size is increased to 16M, this number of table traversals is reduced to only two traversals of the PTE table. It is evident that as the size of the data buffer is increased to a large size such as 256M, the number of PTE table traversals using a 4K page size can become prohibitive. Accordingly, such large data buffers are desirably mapped to large page sizes such as 16M.

Further resources allocated to the master controller include channels allocated from adapter resources, such as CHAN 1, CHAN 2, . . . CHAN N. In addition to the channels, tables are also allocated to the master controller from the Hypervisor, such tables including translation tables TTBL 1, TTBL 2, etc., to use for posting translation information and other miscellaneous tables. Additionally, a pool of data structures DS 1, DS 2, etc., is also allocated, the data structures to be used to contain translation information for the addresses of the most recently and/or most frequently data that is transferred by user applications in that logical partition. The data structures also contain information including use counts from which it is determined which data structures should be retained by the master controller, and which data structures can be purged.

The data structures can be viewed as containing address translation information for much of the “working set” of the data that is referenced in message requests by user applications in a particular logical partition. Ideally, the ratio of the translation information contained in the data structures to the data actually being referenced in message requests should be high. In such case, the data structures serve as a type of cache for translation information relating to data that is frequently being passed in messages from one processor to another over the switch 130. The master controllers' assignment of data buffers to user applications and their use of the data buffers should be arranged such that the data buffers represent relatively small areas of memory such that those areas are more likely to be referenced repeatedly in messages.

Referring again to FIG. 8, at step 810, a request to transmit a message is passed to the master controller for a particular logical partition from a user application, e.g., MPI, of that logical partition. In such case, the MPI can be considered a “user application” of the logical partition. Alternatively, an actual end user application may call MPI to send such message. At step 820, the master controller assigns the communication resources from the pools which are needed to prepare and send the message. One resource, a data buffer, is already assigned to a particular user application prior to the step of the user application requesting a message be sent. The user application on one processor then uses the data buffer in expectation of transferring its contents by a zero copy mechanism to another processor, i.e., another processor within the computing system or which is accessible through an external network. Thus, as indicated at step 820, when the user application makes the message request, additional resources are assigned which are specifically needed to send the message. With additional reference to FIG. 9, these resources include a channel 920, a translation table 930, and miscellaneous tables 940. A kernel data structure 950 is also assigned, if not already in existence due to the prior assignment of a data buffer and the user application having already made a message request against that data buffer. The channel identifies the adapter resource that will be used in transmitting the message. The translation table will be used to contain translation information for translating the addresses belonging to the data buffer into physical page addresses needed by the adapter to transmit the message.

Thereafter, in operation, the master controller monitors the resources available in each pool, as shown at 830. Certain resources such as channels and translation tables are used only once by a particular user application, e.g., MPI or GPFS, during the sending of a particular message and then are returned to the master controller again for reassignment in response to another message request. Therefore, these resources remain available after each use. However, certain other resources such as the data buffers and data structures can be assigned to a user application and then used by that application over a longer period of time. In such case, at step 840 the master controller determines which of the resources are still needed. The master controller does this by determining which of the resources have been used most recently or most frequently, and which others, by contrast, have not been used as recently or frequently. For those resources which have not been used recently or frequently, the master controller returns them (step 850) to the corresponding pools for re-allocation according to subsequent requests. In doing so, the master controller informs the user application that the resource has been de-allocated. In addition, if the monitoring indicates that the number of such resources in the pool is more than the master controller expects to need for subsequent message requests, the resource is returned to the privileged resource owner, i.e., the Hypervisor, operating system and/or adapter.

Also, as indicated at step 860, the master controller monitors the amount of resources available in the pools, and if it appears that an additional resource will be needed soon, then the master controller requests its allocation, and the Hypervisor, operating system, and/or the adapter then allocate the requested resource, as indicated at 870. The arrow that closes the loop to step 810 at which the master controller assigns a data buffer to a user application indicates that the master controller performs an ongoing process of monitoring the use of and re-assigning resources for messages from the pools. Likewise, the master controller also obtains privileged resources to add to the pools from the owners (Hypervisor, operating system, adapter) of the resources as needed, and returns them when no longer needed.

A method of transmitting a message by way of a zero copy mechanism will now be described with respect to FIG. 10. As shown at step 1000, the master controller assigns a data buffer to a user application at the request of the user application. The user application then uses the data buffer to store data that it may wish to transmit by a zero copy mechanism. At step 1010, the user application requests from the master controller that a message be transmitted, passing the parameters VADDR (the virtual address for the beginning of the range of data to be transferred) and MSGLENGTH (the length of the message to be transferred). In response, at step 1020, the master controller assigns a channel, translation table, miscellaneous tables, and a data structure from the pools of communication resources it maintains, these resources being needed to transmit the message via a zero copy mechanism. Thereafter, at step 1030, it is determined whether address translation information, e.g., translation control elements (TCEs), exist for the range of data to be transferred at the particular virtual address. Some or all of the translation information may already exist as entries on a kernel data structure previously allocated for use in transmitting a message by the user application. In such case, from the data structure the master controller has pointers to the TCEs for the data buffer that was previously translated and sent via a previous message request. These TCEs are then stored to the translation table, as indicated at 1033.

As discussed above, the data structure holds a number of TCEs that correspond to the number of page addresses that were referenced by a previous message. The data structure also includes use counts indicating which TCEs have been used most frequently and/or most recently. Those TCEs which have been used less frequently or recently are discarded, by overwriting them with more recently used TCEs. However, in each case, the master controller associates one virtual address and one continuous range of memory with each data structure. If all TCEs already exist in a data structure for the message to be transmitted, then the translation table is loaded with the TCEs from the data structure. On the other hand, some TCEs for the message to be transmitted may exist in a data structure for a previously transmitted message, while others of the TCEs do not. In such case, the TCEs that exist in that translation table for part of the message are placed in the translation table and only those addresses which have not been previously transmitted are now translated.

When address translation still needs to be performed, desirably, one or more time-saving techniques are used to obtain and provide the translation information to the adapter in an efficient way, as indicated at 1035. One technique is to reduce the number of traversals of the PTE table that are required to pin and translate each page of the data to be sent. As discussed above, one way to do this is to assign data buffers that are mapped according to large pages, e.g., 16M pages, when assigning very large data buffers, e.g., those of size 32M and greater. In such case, the number of traversals of the PTE table is reduced by a factor of 4K. Thus, for a large region of memory such as the 32M example discussed above, while 8K traversals of the PTE table are ordinarily performed when the data buffer is mapped to 4K size pages, only two traversals of the PTE table are required when the data buffer is mapped to 16M size pages.

According to an embodiment of the invention, another technique provided to reduce the number of traversals of the PTE table is the use of simultaneous pinning and translation of the pages of the message to be sent. As discussed above relative to FIGS. 7A-7B, conventional pinning and translation techniques required that the PTE table be traversed twice for address translation to be performed on each page, once to pin each page to be transferred by the message, and once more to obtain translation information for each page to be transferred. Since traversing the PTE table actually required traversing a chain of two or more tables, and the PTE table is traversed twice for each page, then at least four table traversals were required per page of memory to be transferred. In the embodiment of the invention described herein, the number of traversals of the PTE table is cut in half, from four to two, by simultaneously pinning and translating the pages to be transferred. Referring to FIG. 7A, in this embodiment, a first table 700 is consulted to identify a second table (Table 2) 710 on which translation information for the page is located. Then, in a modification of that shown in FIG. 7A, the page translation information (PTE) is obtained for a particular page in the same lookup to Table 2 in which that page is pinned. There is no need to again consult the first table 700 and then Table 2 (710), because the translation information for each page is already obtained when each page is pinned. By simultaneously pinning and translating each respective page on each traversal of the PTE table in this manner, the PTE table is only traversed once for each page being translated instead of twice, as in the prior art.

This is further highlighted by returning to the previous example described as background of the invention. By the prior art method, when the message payload length is 16M, the number of times that the PTE table is traversed to pin each address is once for every page, which is 16M/4K, i.e., 4K times. Since traversing the PTE table requires traversing a chain of at least two tables, then 8K table traversals are required to pin the addresses. As also described above, an additional 8K table traversals are required to translate the addresses, Thus, a total of 16K table traversals are required to perform the necessary address translation for a 16M message. However, by the method according to this embodiment of the invention, since the PTE table is traversed only once instead of twice, the number of table traversals is reduced by half to 8K.

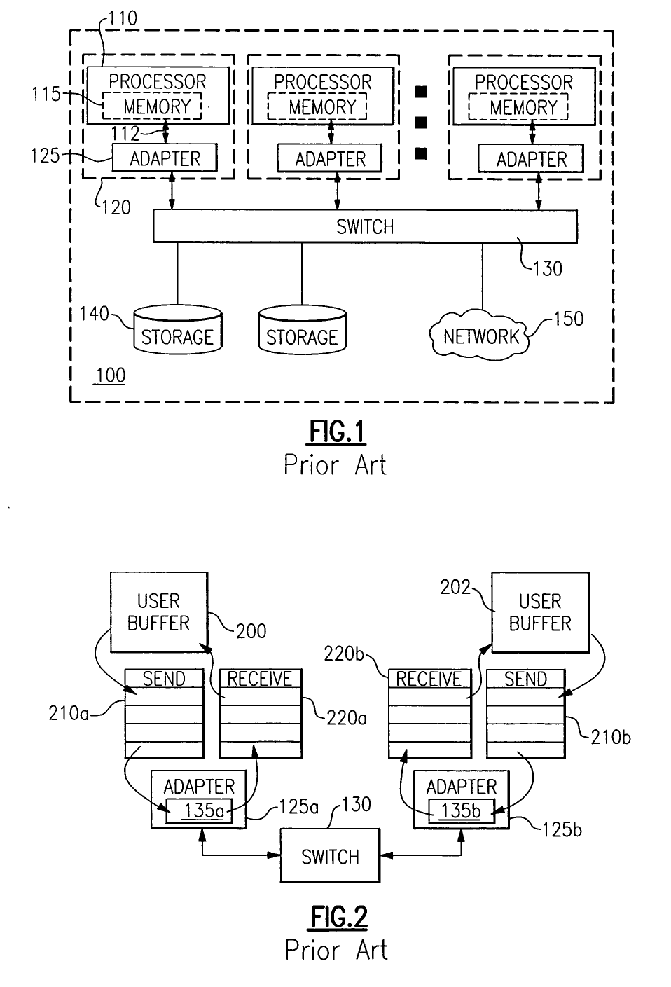

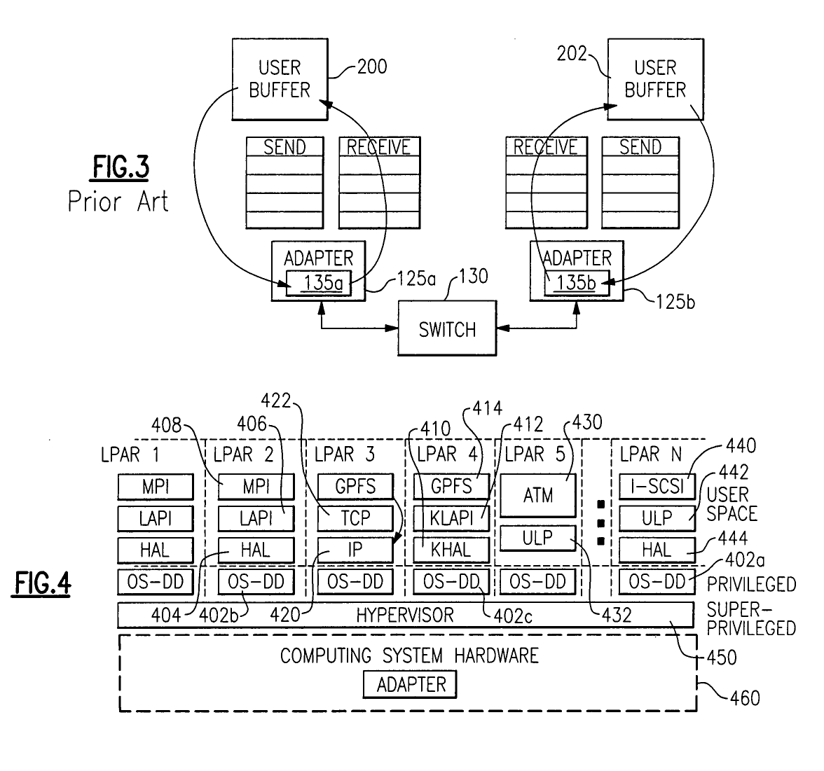

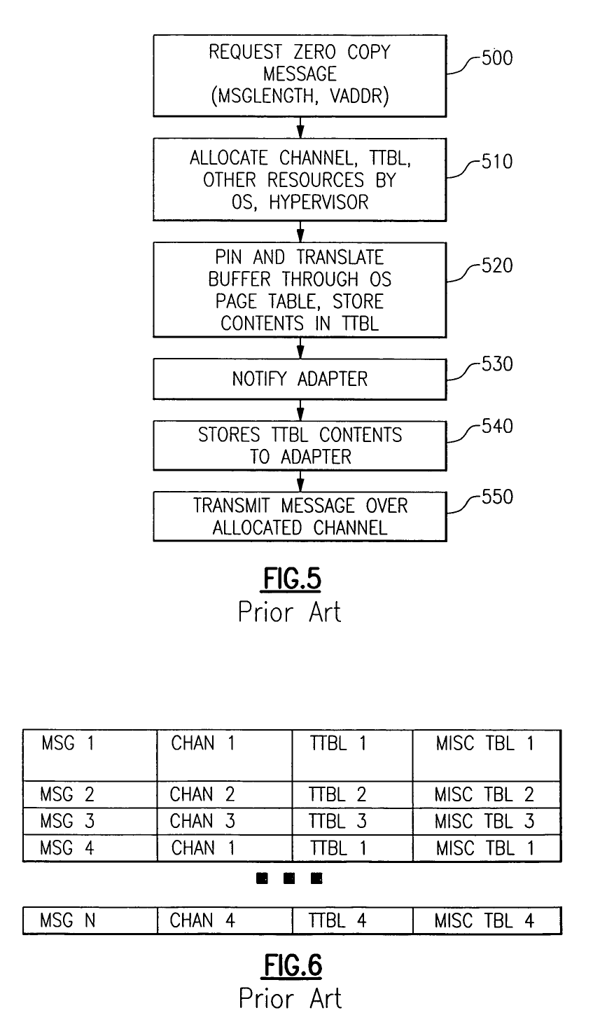

In one embodiment, another technique used to reduce the time associated with translating addresses is to pack the translation information in the translation table. Referring to FIG. 1, in an example, a bus 112 between the processor 110 and adapter 125 at each node 120 has a hardware transfer width of 128 bytes per transfer. In one embodiment, the hardware transfer width is set at 128 bytes to match the cache line size of the processor 110. In conventional systems, TCEs are entered into a translation table in such way that, when the translation table is provided to the adapter over the bus 112, only one TCE is transmitted over the bus per each 128 byte transfer. It then follows that, according to the prior art, the effective transfer rate of the TCEs between processor and adapter is only ⅛ of the bus transfer rate along the processor adapter bus 112.

By contrast, in this embodiment of the invention, eight TCEs are packed into each 128 byte wide area of the translation table, such that when each 128 byte transfer occurs along the bus 112, eight TCEs are transferred from the processor 110 to the adapter 125. Accordingly, transfer of packed TCEs along the processor adapter bus 112 in this manner represents an eight-fold increase in the transfer rate of TCEs to the adapter.

As shown at step 1040, once the translation information is ready, the adapter is notified that there is data to be sent, and the translation table (TTBL) to be used is identified to the adapter. Other information such as the channel to be used is also identified to the adapter at this time. Thereafter, at step 1050, the adapter stores the contents of the translation table to its own memory, and then, at step 1060, the adapter transmits the message over the allocated channel across the switch to the receiving processor. This is the usual process used when a message has an average length, e.g., of 1M.

However, occasions exist where it is desirable to handle a request to send a large amount of payload data by sending the payload data as two or more messages each carrying a portion of the payload data, at least some messages of which can be transmitted simultaneously. This way of handling a message request is called “striping.” Referring to FIG. 1, through striping, it is possible to reduce latency for transmitting a message between processors 110, because the smaller size messages are transmitted simultaneously, instead of the message having to be transmitted sequentially from beginning to end.

As discussed above as background to the invention, despite the advantages of zero copy messaging for larger size messages, the amount of setup time required therefor makes zero copy messaging too costly for smaller size messages. While the improvements described herein seek to reduce the setup time required for messaging by way of a zero copy mechanism, there is still a crossover point in the size of the message to be transmitted at which it would take less time to transmit the message by way of a copy mode mechanism rather than the zero copy mechanism. In the embodiment of the invention illustrated in FIG. 11, this crossover point is recognized, in that a payload data length threshold is utilized to determine whether or not the message should be sent by way of a zero copy mechanism or by a copy mode mechanism. Thus, in the example shown in FIG. 11, a message request is received at 1110. Thereafter, at 1120, the master controller determines whether the payload length of the data to be sent exceeds a predetermined threshold. If the payload length is smaller than the threshold, then a copy mode mechanism is used to transmit the message, as shown at 1130. Otherwise, if the payload length exceeds the threshold, the message is set up for transmission via a zero copy mechanism, as shown at 1140. Also, as shown at 1150, it is also determined whether a threshold for striping the message has been exceeded. If the payload data length is higher than the threshold, then the message is striped as a plurality N of messages, as shown at 1160, and transmitted (1170).

In an embodiment of the invention, at least N−1 (one less than N) messages each have the same data payload length that is determined according to a desired striping size, and one message contains the remainder of the data. However, in another embodiment of the invention, striping is performed using messages having different data payload lengths. For example, one message request to transmit a message of length 8M could be striped according to the one embodiment as eight messages each having a data payload length of 1M. In another embodiment, as an example, an 8M message could be striped as four messages, one having a data payload length of 4M, one message having a data payload length of 2M, and the other two messages having a data payload length of 1M each.

In one embodiment, the threshold used to determine whether a requested message having a data payload length L should be striped as a plurality N of zero copy mode messages each having a data payload length L/N is based on the relation between the amount of setup time T_{S} needed to prepare the requested message for transmission as the N striped messages and the transit time T_{TR} of the requested message across the bus 112 (FIG. 1). In a particular embodiment, when deciding whether the requested message should be striped, the governing relationship is whether the setup time T_{S} for preparing the N striped messages is less than 1/Nth the transit time T_{TR} for the requested message. When the requested message is large, N can be a large number and is preferably a power of two, e.g., N=4, N=8, N=16, N=2^{m} etc. It is apparent that N=2 is the lowest number of messages that can be used to stripe a message. As an example, it is assumed that a user application requests a particular message be transmitted having a length L of 0.5M, for which the transit time T_{TR} is
L/Bus rate=0.5M/1.5 GBs=340 μsec.

By the above relation, the threshold for striping the 0.5M message as two zero copy mode messages is that the setup time T_{S} for preparing the two striped messages is less than ½ of the transit time. Specifically, in this example, the setup time T_{S} for preparing the two striped messages, each having length 256K, should be less than 170 μsecs for the requested 0.5M length message to be striped. Using techniques provided according to the embodiments of the invention, the setup time T_{S} for preparing striped zero copy mode messages having 256K lengths is reduced to about 120 μsecs. Such small setup time applies, for example, when the message is able to be sent without requiring address translation because the data buffer referenced by the message request has already been translated and a data structure contains the needed translation information.

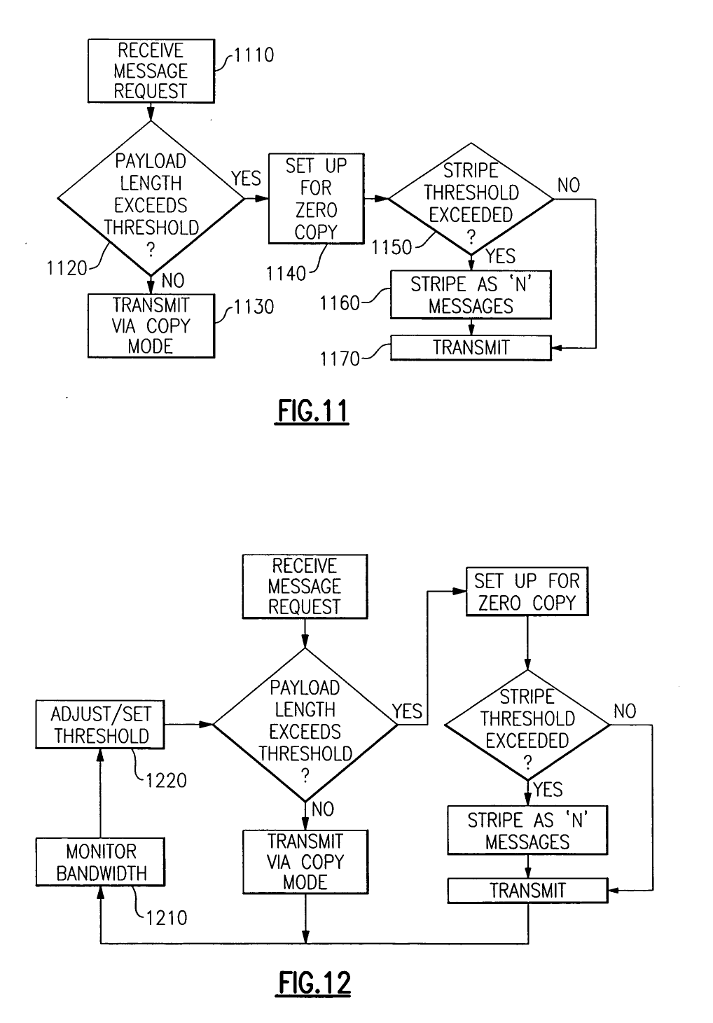

FIG. 12 illustrates a further embodiment. As shown therein, the threshold used to decide between use of the zero copy mechanism and the copy mode mechanism is adjustable. As represented by FIG. 12, all operations performed are the same as those shown and described above with respect to FIG. 11, with the exception of now providing “closed loop” operation. In this case, a step 1210 is added for monitoring the message transmission bandwidth. Such monitoring is performed at intervals, e.g., an interval for transmitting 64 packets, each having 2K bytes each. Based on such monitoring, at step 1220, the threshold can be set and/or adjusted for messages sent thereafter.

The time required to send data via each of the copy mode and zero copy transport mechanisms will now be described. An equation for the copy mode transfer time T_{C} to send a message of length L via a copy mode mechanism is:
T_{C}=m_{C}L+C_{C}
where m_{C} is the time interval per byte corresponding to the copy rate, for example 1/1 GBs (gigabyte/sec), and C_{C} is a constant time interval, e.g., 40 μsecs to account for latency in copying the data into the FIFO pinned memory and latency in handshaking across the bus 112 (FIG. 1) and for receiving acknowledgement that the packet is received at the other end.

Thus, the copy mode transfer time for a 0.5 M length message is determined as
T_{C}=0.5 M/1 GBs+40 μsecs=488+40=528 μsecs.

Bandwidth is a measure of the amount of data transmitted per unit of time. Therefore, for this message having a particular length of 0.5 M, the copy mode bandwidth is 0.5 M/528 μsecs=947 MBs (megabytes/sec).

On the other hand, the zero copy transfer time is determined by another equation as follows:
T_{Z}=m_{Z}L+K_{Z}+C(L)

where m_{Z} is the time interval per byte corresponding to the bus transfer rate, for example 1/1.5 GBs (gigabyte/sec), and K_{Z} is a constant time interval, e.g., 60 μsec, to account for latency in obtaining the needed resources, e.g., translation table, channel, etc., and C(L) is an amount of time which varies according to the amount of data to be transferred. It generally takes longer to perform the necessary translations for a larger amount of data than it does for a smaller amount of data. C(L) accounts for this variable element of the time. In an example, for a message having a payload length of 0.5 M, the numbers are as follows:
T_{Z}=0.5 M/1.5 GBs+60 μsecs+80 μsecs=326 μsecs+140 μsecs=466 μsec.

The corresponding bandwidth is 0.5 M/466 μsecs=1072 MBs. Thus, in this example, since T_{Z} is lower than T_{C} and the zero copy bandwidth BW_{Z} is higher than the copy mode bandwidth BW_{C}, the decision should be to use a zero copy mechanism to send the message. On the other hand, if the message payload length is smaller, such as 200K bytes, for example, the above equations would lead to the opposite result, i.e., that the copy mode transport mechanism should be employed to transfer the message rather than the zero copy mechanism.

In another example, in a particular computing system, the copy rate is 1.7 GBs and the bus transfer rate is 2 GBs. Plugging these rates into the above equations,

the copy mode transfer time becomes:
T_{C}=0.5 M/1.7 GBs+40 μsecs=287 μsecs+40 μsecs=327 μsecs.

and the zero copy transfer time becomes:
T_{Z}=0.5 M/2 GBs+60 μsecs+80 μsecs=244 μsecs+140 μsecs=384 μsec.

Under these conditions, the setup time for the zero copy transfer time is a greater factor in the equations. Therefore, in this case, the threshold should be set higher than 0.5 M for zero copy transfer mode.

In a further example, it is assumed that a 2M message is to be sent and that the total setup time for the zero copy mode message is now 200 μsecs instead of 140 μsecs as before. In that case, the message should be sent via a zero copy transport mechanism because the copy mode transfer time becomes:
T_{C}=2 M/1.7 GBs+40 μsecs=1148 μsecs+40 μsecs=1188 μsecs

and the zero copy transfer time becomes:
T_{Z}=2 M/2 GBs+200 μsecs=976 μsecs+200 μsecs=1176 μsec,
which is less than the copy mode transfer time.

However, certain conditions may change during operation of the processor, such as when the processor is under high demand conditions and resources take longer to obtain. Under such conditions, the fixed and variable amounts of time required to set up a zero copy message may increase, and the bandwidth monitoring facility 1210 may detect a decrease in the zero copy bandwidth BW_{Z} to a level below the copy mode bandwidth BW_{C}, for messages having a particular size that is close to the threshold level. In such case, control is exerted, as shown at 1220, to adjust the threshold to a new value which is more appropriate to the current conditions. Thereafter, the new value is used for deciding whether a zero copy transport mechanism or a copy mode mechanism should be used. In an embodiment, the monitoring of such bandwidths is not based on just one measurement at each interval, but rather, is based on a collection of measurements that are taken over time. In such case, the bandwidth measurement for each mode of transmission represents a filtering of such measurements. For example, a simple moving average formula can be applied to average the measurements over a most recent interval of interest, e.g., ten sampling intervals.

As discussed above, a sampling interval for zero copy operation may be that required for transmitting 64 packets, each packet containing 2K bytes. In such a case, the interval needed to transfer the 128 K bytes is approximately 81 μsec, at the bus transfer rate of 1.5 GBs. Then, averaging is performed over an interval for taking 10 samples, which takes 10×81 μsecs=810 μsecs. However, in an embodiment, the more recent of the measurements are weighted more heavily, e.g., the weightings of the most recent of the 10 sampling intervals count for much more in the moving average, such that the moving average is more reflective of the most recent interval than the measurements which were taken earlier. For the copy mode mechanism, since the message length is usually smaller than for zero copy mechanisms, then the sampling interval is preferably made somewhat shorter than the 81 μsecs interval used for the zero copy mode. Likewise, the averaging interval can be made correspondingly shorter than the 810 μsecs example interval for zero copy mechanisms.

In addition, provision is made for varying the interval at which the bandwidth is monitored at step 1210. It is recognized that different system conditions could cause the zero copy bandwidth and the copy mode bandwidth to sometimes vary only slowly, while varying more rapidly at other times. In recognition of this, in one embodiment, it is a goal to obtain samples of the bandwidth at a sufficient sampling rate to fully determine the frequency at which these raw samples of bandwidth measurements vary. From sampling theory, in order to obtain complete data for determining the frequency at which these sampled bandwidths vary, the Nyquist criterion must be satisfied, i.e., the sampling rate must be higher than twice the maximum rate that the bandwidth measurements vary. Moreover, since the rates of change of the copy mode bandwidth and the zero copy bandwidth change over time, in this embodiment, the sampling rate is also varied over time, according to observed system conditions.

While the invention has been described with reference to certain preferred embodiments, those skilled in the art will recognize the many modifications and enhancements which can be made without departing from the true scope and spirit of the invention, which is limited only by the claims appended below.

1. A method of facilitating zero-copy communications between computing systems of a group of computing systems, comprising:
allocating, in a first computing system of the group of computing systems, a pool of privileged communication resources from a privileged resource controller to a communications resource controller; and
from the pool, the communications resource controller designating ones of the privileged communication resources for use in servicing the zero-copy communications, thereby avoiding a requirement to obtain individual ones of the privileged resources from the privileged resource controller at setup time for each respective zero-copy communication.

2. The method as claimed in claim 1, wherein the communications resource controller monitors an amount of each privileged communication resource designated to individual user applications and requests additional privileged communication resources when the amount of privileged communication resources available to be designated falls below a minimum threshold.

3. The method as claimed in claim 1, wherein the privileged resource controller is at least one of a Hypervisor, an operating system kernel and an adapter.

4. The method as claimed in claim 3, further comprising:
at the first computing system, receiving a request to transfer a set of application data by one message between the first computing system and a second computing system of the plurality of computing systems;
transferring the set of application data via a zero copy transport mechanism when the message payload length exceeds a threshold; and
transferring the data via a copy mode transport mechanism when the message payload length does not exceed the threshold.

5. The method as claimed in claim 4, further comprising setting the threshold dynamically.

6. The method as claimed in claim 5, wherein the threshold is set based on monitoring, during the normal operation of the first computing system, an amount of setup time required to prepare the set of application data for transmission at the first computing system to at least one other of the plurality of computing systems via a zero copy transport mechanism, an amount of transit time of the application data from the first computing system to the adapter, and an amount of copy time required to copy the set of application data via a copy mode transport mechanism to a pinned buffer for transmission via a copy mode transport mechanism.

7. The method as claimed in claim 6, wherein the threshold is set a priori.

8. The method as claimed in claim 7, further comprising setting the threshold at the initialization time of the first computing system based on prior determinations of the setup time, the transit time and the copy time.

9. The method as claimed in claim 1, wherein the communications resource controller designates a first communication resource of a first type for use in facilitating a first zero-copy communication, the first communication resource selected from a pool of communication resources of the first type, and designates a second communication resource of a second type for use in facilitating the first zero-copy communication, the second communication resource selected from a pool of communication resources of the second type independently from the selection of the first communication resource.

10. The method as claimed in claim 4, wherein the step of transferring the set of application data by a zero copy transport mechanism includes referring to a page table to obtain translation information for the set of application data, using the obtained translation information to transfer the set of application data, storing the obtained translation information in a data structure, the method further comprising using the obtained translation information stored in the data structure to transfer a second set of application data in response to a subsequent request received by the first computing system.

11. The method as claimed in claim 10, wherein the step of designating a first communication resource of a first type includes establishing a plurality of data buffers including a first data buffer having a first region size and a first page size and a second data buffer having a second region size larger than the first region size and a second page size larger than the first page size, designating at least one of the first data buffer and the second data buffer for use by a first user application, wherein the request to transfer the set of application data requests that data be transferred from one of the first and second data buffers and the step of obtaining translation information for the set of application data is carried out in terms of the corresponding one of the first page size or the second page size of the requested first or second data buffer from which the set of application data is to be transferred.

12. The method as claimed in claim 4, wherein the step of transferring the set of application data by the zero copy transport mechanism includes obtaining translation information for the set of application data, packing the translation information by the first computing system for a plurality of pages of the set of application data into respective rows of a table having width of at least the hardware transfer size of the adapter connected to the first computing system, each row packed with the translation information for a plurality of the pages, and transferring the translation information to the adapter in units of the hardware transfer size, each unit of the hardware transfer size containing the translation information for a plurality of the pages.

13. The method as claimed in claim 12, wherein the first page size is 4K and the second page size is a 16M.

14. The method as claimed in claim 12, wherein the translation information for each page has a width of 16 bytes and the hardware transfer size is 128 bytes, such that the translation information for eight pages is simultaneously transferred to the adapter.

15. The method as claimed in claim 14, wherein the hardware transfer size is the same as the cache line size of the first computing system.

16. A machine-readable medium having instructions recorded thereon for performing a method of facilitating zero-copy communications between computing systems of a group of computing systems, the method comprising:
allocating, in a first computing system of the group of computing systems, a pool of privileged communication resources from a privileged resource controller to a communications resource controller; and
from the pool, the communications resource controller designating ones of the privileged communication resources for use in servicing the zero-copy communications, thereby avoiding a requirement to obtain individual ones of the privileged resources from the privileged resource controller at setup time for each respective zero-copy communication.

17. The machine-readable medium as claimed in claim 16, wherein the communications resource controller monitors an amount of each privileged communication resource designated to individual user applications and requests additional privileged communication resources when the amount of privileged communication resources available to be designated falls below a minimum threshold.

18. The machine-readable medium as claimed in claim 17, wherein the privileged resource controller is at least one of a Hypervisor, an operating system kernel and an adapter.

19. The machine-readable medium as claimed in claim 18, wherein the method further comprises:
at the first computing system, receiving a request to transfer a set of application data by one message between the first computing system and a second computing system of the plurality of computing systems;
transferring the set of application data via a zero copy transport mechanism when the message payload length exceeds a threshold; and
transferring the data via a copy mode transport mechanism when the message payload length does not exceed the threshold.

20. A communications resource controller operable to facilitate zero-copy communications between computing systems of a group of computing systems, comprising:
means for allocating, in a first computing system of the group of computing systems, a pool of privileged communication resources from a privileged resource controller; and
means for designating ones of the privileged communication resources from the pool for use in servicing the zero-copy communications, so as to avoid a requirement to obtain individual ones of the privileged resources from the privileged resource controller at setup time for each respective zero-copy communication.
